(19) United States
(12) Patent Application Publication
(10) Pub. No.: US 2006/0042178 A1
(43) Pub. Date: Mar. 2, 2006

(54) Garden window sub frame assemblies

(76) Inventors: Karl Hetzel, Visalia, CA (US); Jeff Schultz, Monroeville, PA (US)

Correspondence Address: MARK D MILLER;KIMBLE, MACMICHAEL & UPTON, 5260 NORTH PALM AVENUE, SUITE 221, FRESNO, CA, 93704, US

(21) Appl. No.: 11/212,236

(22) Filed: Aug. 25, 2005

Related U.S. Application Data
(60) Provisional application No. 60/604,871, filed on Aug. 27, 2004.

(51) Int. Cl. E06B 3/30

(52) U.S. Cl. 52/204.53

(57) ABSTRACT

Garden window sub frame members for inclusion in a garden window frame assembly are disclosed. The garden window sub frame members include a section with sufficient width to at least partially cover an existing window frame in a replacement application, or pocket in masonry or other flush opening. The garden window sub frame members include provision for easily attaching a variety of interior trim sections to accommodate various finish applications. The garden window sub frame members include a channel shaped to accept a flange insert to allow multiple means of attaching the garden window to a structure. The flange insert includes an extension disposed perpendicular to the flange that may also be used to attach the frame member to the structure or provide an exterior finish, or both.

This application claims the benefit of U.S. Provisional Application No. 60/604,871, filed on Aug. 27, 2004, which is incorporated herein by this reference.

### BACKGROUND OF THE INVENTION

1. Field of the Invention

The present invention relates to garden window frame construction, and more specifically to garden window sub frame members having flanges for installation in flush opening conditions, with channels for accepting second flanges that allow installation in a replacement application, the second flanges also providing an exterior finish and covering siding or sheathing attached to the exterior surface of a building structure.

2. Description of the Prior Art

Typically garden window frame nailing flanges extend radially from the garden window, at the innermost plane of the window. The garden window frames are typically installed during new construction of a building, such as a house, or during replacement of existing windows.

During new construction, a garden window frame is normally installed within a rough opening formed within and defined by the frame of a building structure. Typically, a garden window frame installation in new construction applications uses the nailing flange extending radially from the window frame and around the rough opening. During installation, nails, staples or other fastening means are used to secure the radial nailing flange, and thus the garden window frame, to the opening framing.

In masonry construction, garden windows typically are not used because of the difficulty in incorporating the radial flange in the window opening, whether the application is in new construction or as a replacement of an existing window.

Replacement window frames are often installed over an existing window frame of a building, either during renovation of the structure or during replacement of the building's windows. The existing window sash is first removed, and the existing window frame may be prepared for installation of the replacement window frame. The existing frame is usually constructed from wood or from a metal, such as aluminum. Alternatively, the existing window and its frame may be removed entirely, thereby leaving a rough opening in the building structure. This rough opening is then prepared to accept a replacement window frame.

Preparation of the existing frame or rough opening includes several steps, such as removing chips and rough edges in existing wooden window frames, fastening wood blocks into the sash track of, or shimming up, an existing metal frame sill component to help support the weight of the new window, or cleaning and checking a rough frame opening for squareness. The replacement window frame is often secured by driving screws through holes in the interior of the replacement window frame and into the existing frame or rough opening.

A replacement window frame may include a flange, often called a flush fin, that extends radially from the window frame and around the exterior of the window frame opening after installation. See FIGS. 1 and 1A (prior art). The flush fin conceals any gaps created during preparation of the existing window frame or any damaged areas surrounding the window frame or rough opening. Flush fin window designs are often used when replacing window frames in buildings having stucco exteriors. The nuances of new construction and replacement window installation are generally known to window frame installers in the industry and may be found in installation instruction workbooks and manuals published by window frame manufacturers.

Conventional garden window frames with their radial nailing flange do not lend themselves well to either replacement window or masonry construction application. In a replacement application the installation options with a radial flange are to install the window on the exterior of the structure, regardless of the exterior surface composition, or to completely remove the existing window, with its consequent disruption of the structure moisture barrier, and in the case of stucco, disruption of the exterior surface and finish. The steps necessary to prevent disruption of the moisture barrier in the case of removal of the existing window require an extremely high level of skill, and if not performed with such skill, can have grave consequences, such as water damage to interior walls and furnishings. If undetected, such water penetration can over time degrade the structure of the building to dangerously unstable levels.

It is therefore desirable to provide methods and assemblies for installing replacement garden windows onto existing window frames, or into rough openings from which a previous window has been removed, that avoid disrupting the exterior surface and finish and avoid disruption of the existing moisture barrier. It is also desirable to provide garden window sub frame assemblies for use in new construction that are relatively easy to install and which provide a better moisture barrier than existing assemblies. Finally, it is desirable to provide methods and assemblies for use on a replacement garden window that make the interior portion of the garden window more usable and aesthetically pleasing.

### SUMMARY OF THE INVENTION

As herein described, the present invention is a garden window sub frame member for inclusion in a garden window sub frame assembly. The garden window sub frame assembly receives at least one garden window and is configured to be fixedly mounted in an opening in a wall of a structure, the structure having an interior wall and an exterior wall, with the opening defined by surfaces perpendicular to the interior and exterior walls. The garden window sub frame member is defined by an exterior surface disposed proximate to the opening surfaces when the garden window frame assembly is mounted, an interior surface disposed opposite to the exterior surface, a window-facing side disposed to engage the garden window frame and a wall-facing side disposed opposite the window-facing side.

In one embodiment the garden window sub frame member includes a first internal nailing flange and at least one channel formed within the sub frame member. The channel is contained within the cross-sectional area defined by the interior and exterior surfaces and window-facing and wall-facing sides, and is capable of accepting a second flange which, when engaged in the channel, is about perpendicular to the first flange. The second flange provides both a method of attachment to the structure and a substantial finish surface disposed parallel to the exterior wall.

In other embodiments, the first flange may also be configured for accepting trim pieces which may be in a variety of configurations, decorative and utilitarian which may be used to finish the interior of the installed opening as required.

The new garden window sub frame member of the present invention provides several benefits over prior garden window sub frame member designs. First, the present invention provides for installation in masonry or other flush openings directly, without contending with an exterior radial nailing flange and the attendant issues integrating the garden window in a weathertight manner in this type of construction. In particular, one embodiment of the present invention includes only internal flanges that are designed for attachment to an existing window frame, not to the exterior masonry wall. Exterior radial flanges are typically not used in a masonry opening because the lower flange would contend with a sill that typically projects out past the surface of the building. This condition can exist in a retrofit or new construction application.

Masonry construction typically requires that the window frame have provision for installation within a fixed opening, unlike wood construction in which a building finish and weather membrane is applied after window installation, covering any mounting flanges. The second flange may be included or eliminated, depending upon the requirements of the construction (e.g., the second flange would contend with a sill, as above, on a brick wall; however, the second flange would be suitable for use on a block wall without a sill).

Further, the first and second flanges together provide a method of installing a garden window in a replacement application which is in accordance with accepted industry practice, instead of the less-than-satisfactory methods identified above. Additionally, the sub frame member's ability to accept a variety of interior trim and finish allows the garden window installation to be completed with minimal labor.

It is therefore an object of the present invention to provide universal garden window sub frame assemblies and methods suitable for any installation application, leading to significant installation cost savings and competitive advantages.

It is also an object of the present invention to provide garden window sub frame assemblies and methods for direct installation in masonry or other flush window openings.

It is another object of the present invention to provide garden window sub frame assemblies and methods for installation without disrupting the exterior surface and finish nor disruption of the existing moisture barrier.

It is a further object of the present invention to provide garden window sub frame methods and assemblies for use on a replacement garden window that make the interior portion of the garden window more usable and aesthetically pleasing.

Additional objects of the invention will be apparent from the detailed descriptions and the claims herein.

### BRIEF DESCRIPTION OF THE DRAWINGS

FIG. 1 is a profile view, of a typical prior art garden window, with radial nailing flanges.

FIG. 1A is a perspective view in full of a typical prior art garden window, with radial nailing flanges.

FIG. 2 is a profile side view of a garden window of the present invention with an exemplary embodiment of the sub frame with opening parallel flange.

FIG. 2A is a profile top view of a garden window of the present invention with an exemplary embodiment of the sub frame with opening parallel flange.

FIG. 3 is a profile side view of a garden window of the present invention with an exemplary embodiment of the sub frame with opening parallel flange with second flange inserted.

FIG. 3A is a profile top view of a garden window of the present invention with an exemplary embodiment of the sub frame with opening parallel flange with second flange inserted.

FIG. 4 is a perspective view, in full, of a garden window of the present invention with an exemplary embodiment of sub frame members.

FIG. 4A is a perspective view, in full, of a garden window of the present invention with an exemplary embodiment of sub frame members and insertable flanges of FIG. 3 and FIG. 3A.

FIG. 5 is a perspective view of an exemplary embodiment of the garden window sub frame member corner of FIG. 4 depicting the mechanical fastenings giving the corner structure.

FIG. 5A is a perspective view of an exemplary embodiment of the garden window sub frame member corner of FIG. 4A depicting the mechanical fastenings giving the corner structure.

FIG. 6 is an exploded perspective view of the corner of FIG. 5 depicting the details of the mechanical fastenings giving the corner structure.

FIG. 6A is an exploded perspective view of the corner of FIG. 5A depicting the details of the mechanical fastenings giving the corner structure.

FIG. 7 is a profile side view of an exemplary embodiment of the second flange corner joint of FIG. 5A depicting the joint cover.

FIG. 8 is a profile side view of an exemplary embodiment of the garden window sub frame member of FIG. 3 depicting the second flange channel in detail.

FIG. 9 is a profile side view of an exemplary embodiment of the garden window sub frame members of FIG. 3 in a replacement window application.

FIG. 9A is a detailed profile side view of the window frame head sub member of FIG. 9.

FIG. 10 is a profile top view of an exemplary embodiment of the garden window sub frame members of FIG. 2A in a masonry installation application.

FIG. 11 is a profile side view of an exemplary embodiment of the garden window sub frame members of FIG. 3 in a replacement window application with a trim piece finishing the interior opening.

FIG. 12 is a profile side view of an exemplary embodiment of the garden window sub frame members of FIG. 3A with a trim piece depicting the trim piece pocket and lock in detail.

FIG. 12A is a profile side view of an exemplary embodiment of the garden window sub frame member of FIG. 3A with a trim piece depicting the trim piece lock in detail.

FIG. 12B is a profile side view of an exemplary embodiment of the garden window sub frame member of FIG. 3A with a trim piece depicting the trim piece snap off notches in detail.

FIG. 13 is a profile side view of an exemplary embodiment of the garden window sub frame member of FIG. 3A with a trim piece depicting the flush surface formed at the sill of the window and a utilitarian trim piece at the head.

FIG. 14 is a profile side view of an exemplary embodiment of the garden window sub frame member of FIG. 3 and FIG. 3A depicting decorative trim pieces and the flush surface formed at the sill of the window.

FIG. 14A is a profile top view of the exemplary embodiment of the garden window sub frame member of FIG. 3 and FIG. 3A.

### DETAILED DESCRIPTION

A preferred embodiment of the invention is described hereafter using a garden window frame and frame members.

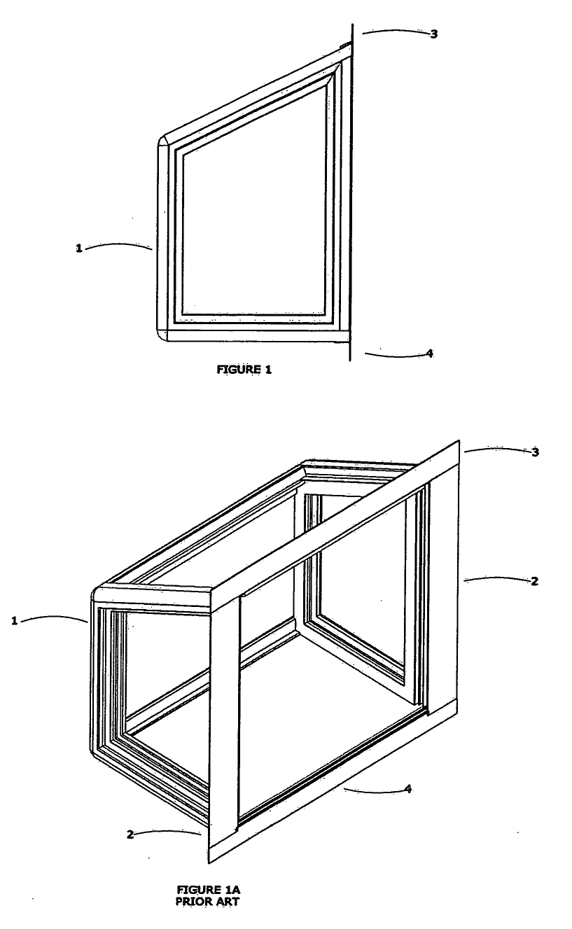

FIG. 1 shows a profile view of prior art, a typical garden window frame 1 with radial head nailing flange 3 and sill nailing flange 4. FIG. 1A shows a full perspective view of a typical prior art garden window frame 1 with radial head nailing flange 3, radial jamb nailing flanges 2, and radial sill nailing flange 4. It should be apparent that such a typical garden window frame is best suited for new construction installation, primarily in structures with typical wood framing.

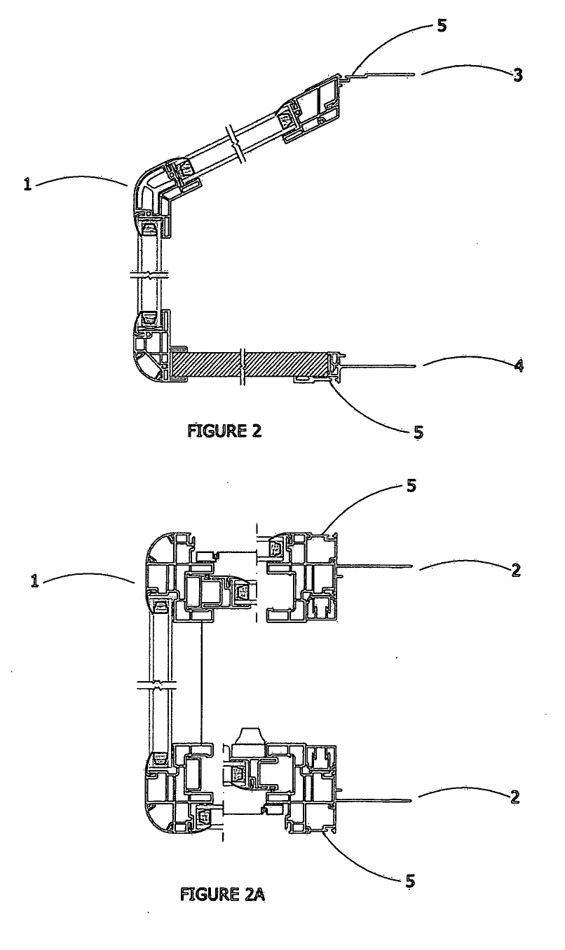

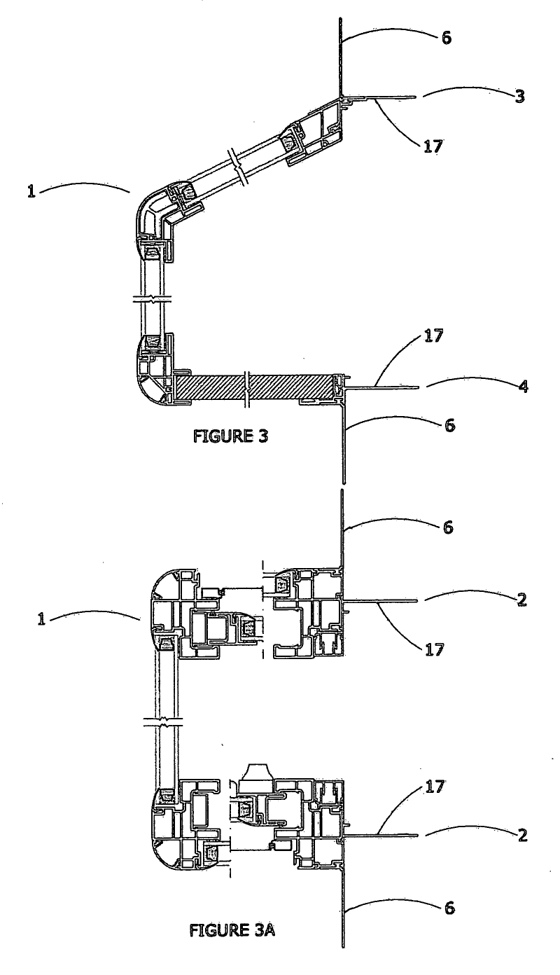

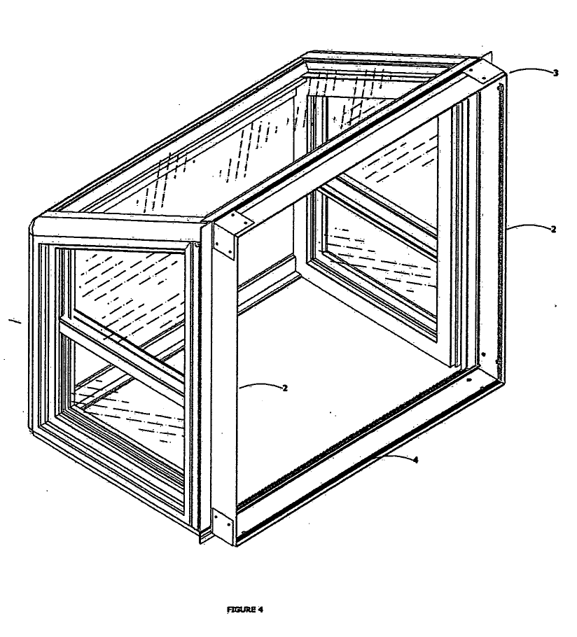

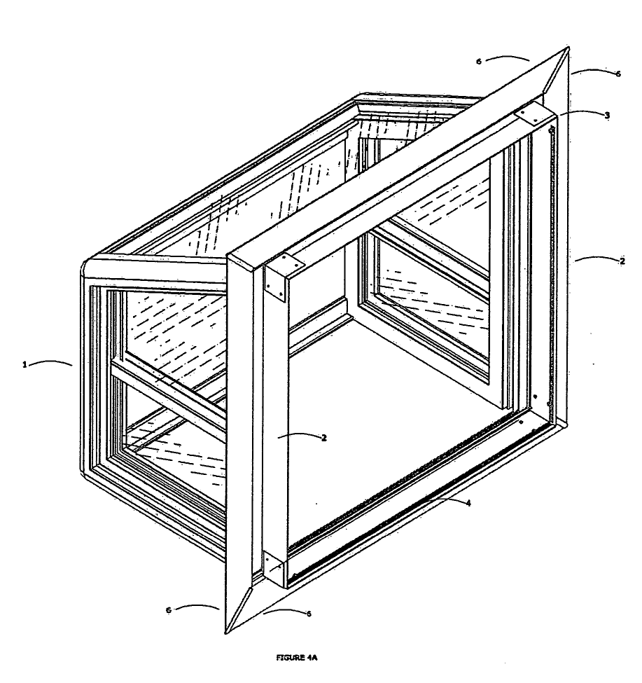

FIGS. 2 and 2A show profile views of the sub frame head member 3, sub frame sill member 4, and jamb sub frame members 2 of the present invention, with channels 5 apparent in both views. Each of members 2, 3 and 4 is elongated, and includes both an exterior flange 19 and an interior flange 17 separated by a channel 5. (See cross sectional view of member 3 in FIG. 8.) The exterior flanges 19 fit adjacent to and engage a portion of the exterior of the garden window as it protrudes out from the window frame, and the interior flanges 17 extend inward into the frame along its interior perimeter. Channels 5 may be of any suitable configuration in order to receive corresponding structures on the optional second flanges 6 for weathertight mounting in channels 5. In the illustrated embodiment, these structures allow for slidable engagement, but other engagement structures may be used allowing for snap fit or other insertion into channels 5. FIGS. 3 and 3A show profile views of the second flange 6 inserted into the channels 5 in the sub frame members, including attachment at the head, sill and side jambs of the window frame. FIG. 4 shows a full perspective view of the preferred embodiment, including first and second flanges in place on garden window frame 1.

The structure of the garden window sub frame members as an integrated part of the garden window frame 1 is described hereafter. Then, the method of accommodating a plurality of garden window installation conditions on a single production line is described.

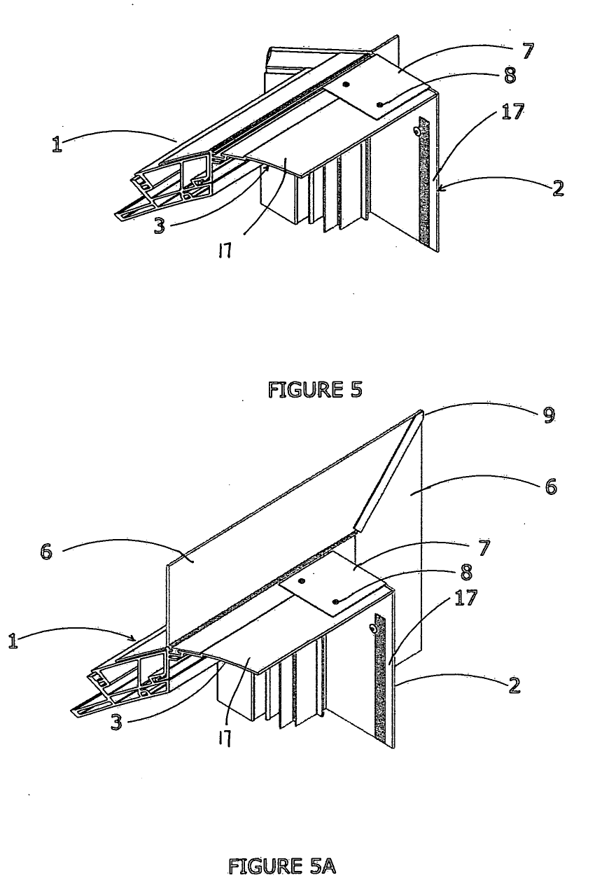

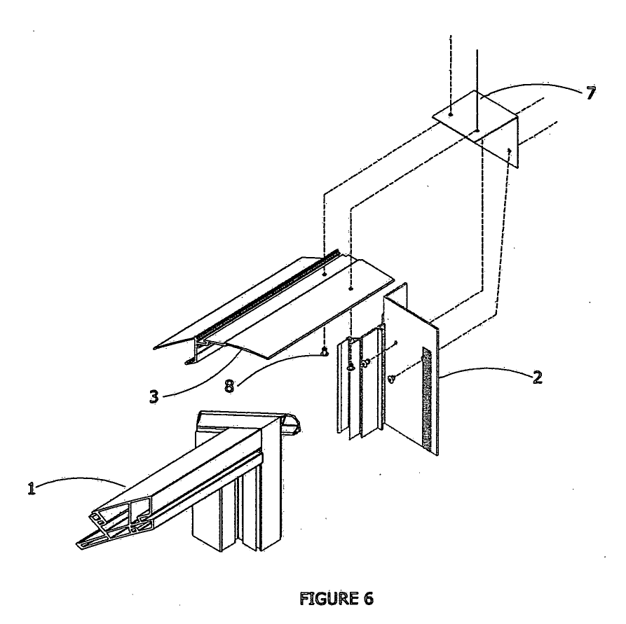

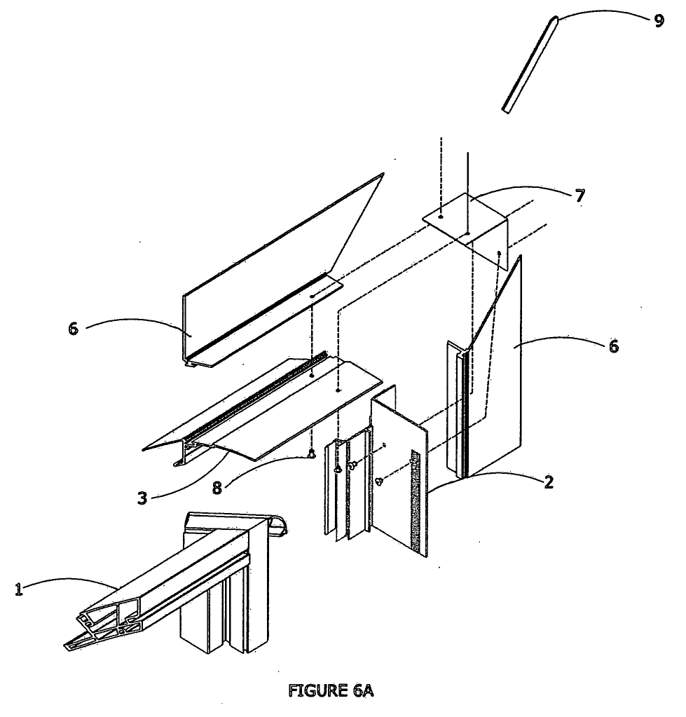

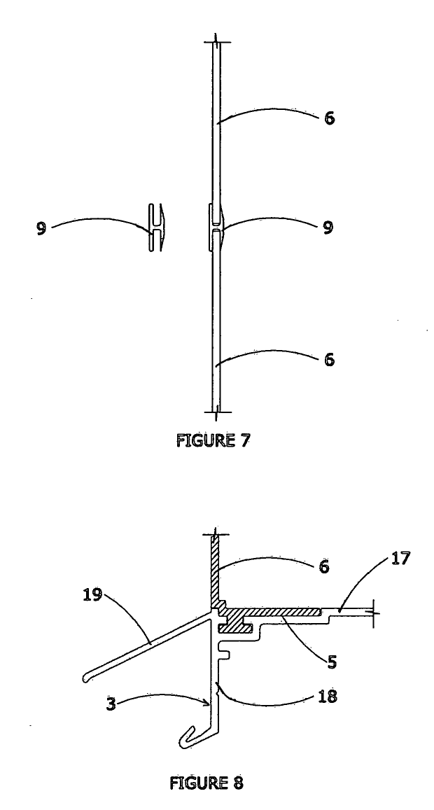

Referring to FIGS. 5 and 6, garden window sub frame members 2 and 3 are shown mechanically joined with yoke plate 7 and rivets 8, providing, with application of a proper sealant, a structurally sound weathertight joint. The corner joining method is essentially the same for all corner joints in the sub frame assembly. FIGS. 5A and 6A show also second flange 6, if second flange 6 is required in the complete garden window frame 1, joined to the sub frame members 2 and 3, both by engagement in channel 5 and held by plate 7 and rivets 8, structurally integrating second flange 6 into the complete garden window frame 1. Additionally, joint cover 9 is used at the mitered juncture of second flange 6, which with application of a proper sealant provides a structurally sound weathertight joint.

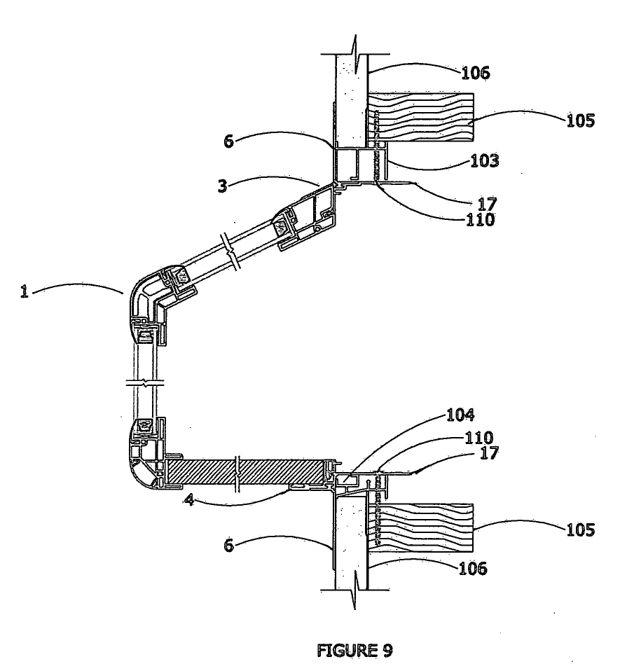

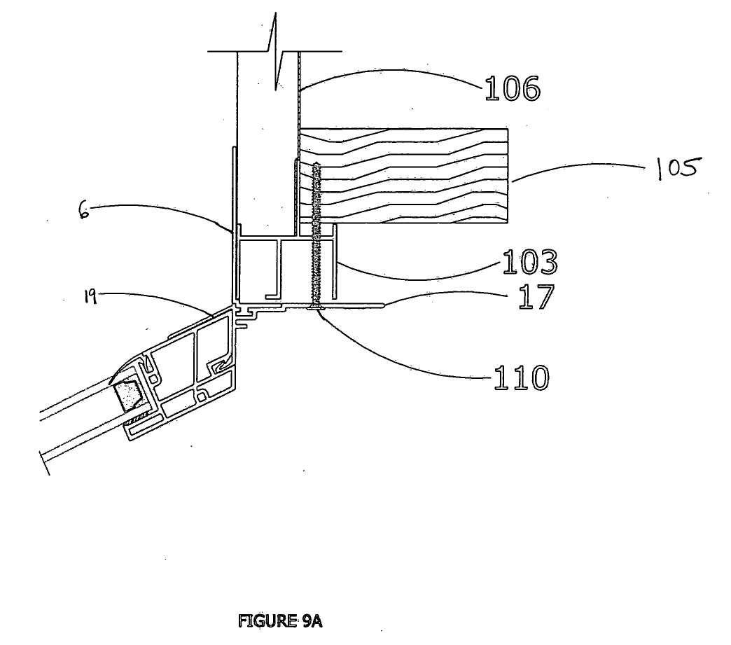

Referring to FIG. 9, a preferred embodiment of the invention can be seen in a replacement window application, where the garden window frame 1 with sub frame members 3, 4 and 6, are installed as a whole (sub frame members 2 are also present, but not illustrated in the view of FIG. 9) in a structure opening bounded by existing window frame head member 103, existing window frame sill member 104, framing 105, and exterior finish 106, in this case represented as stucco, but which could be any exterior structure finish. It can be seen that the sub frame members 2, 3 and 4 cover the existing window frame, and provide a means for fastening the garden window frame 1 to the opening such as with a fastener 110 (such as a nail or screw) driven through flange 17 without penetrating the exterior finish and risking degradation of the structure moisture barrier. It can be seen that second flange 6 provides a radial “flush fin” that covers the exterior of the existing frame and structure opening. Proper sealant applied behind the flush fin (between flange 6 and the exterior finish 106) increases the weatherability of a replacement window installation. Additional fasteners may also be installed that penetrate through flange 6 into exterior finish 106, and potentially into framing 105.

It is to be appreciated that second flanges 6 may be omitted as shown in FIGS. 2 and 4, for example in a masonry window opening having a lower sill, such that the garden window sub frame is made up of only members 2, 3 and 4, and is attached to the window frame using only fasteners 110 driven through flanges 17 into framing 105. Presumably, a proper moisture barrier already exists between framing 105 and the head (103), sill (104) and side members of the window frame that is not affected by fasteners 110. However, a sealant may be applied between flanges 17 and these frame members to improve the moisture barrier.

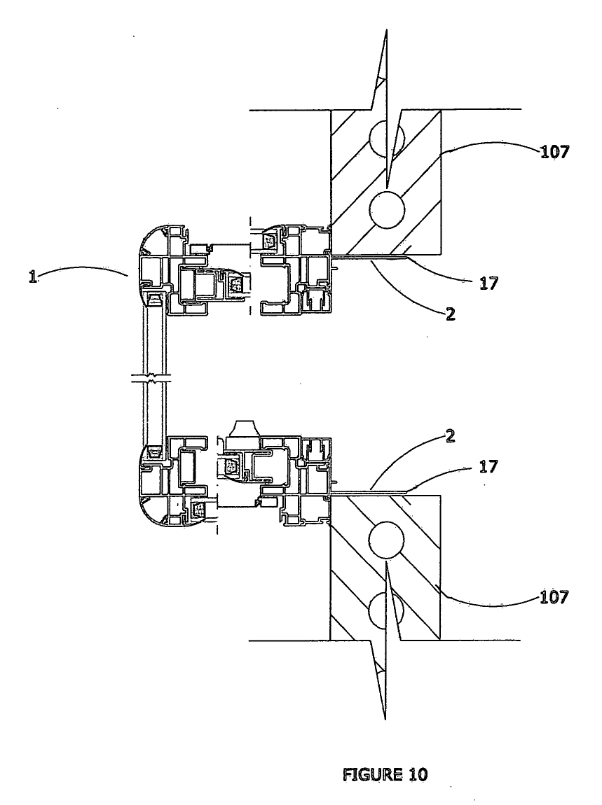

Referring to FIG. 10, a preferred embodiment of the invention can be seen in a masonry installation, where the garden window frame 1 with jamb sub frame members 2 are installed as a whole in a structure opening bounded by structure jambs 107. While in this perspective it is not visible, the opening flanges of the parallel side sub members 2, and head and sill members 3 and 4 provide an anchoring and sealing surface that integrate into the structure moisture barrier. The moisture barrier is created by providing a proper sealant between flanges 17 of these sub members and the structure jambs 107. This avoids the difficulties presented in prior art garden windows where the only available moisture barrier is between the radial nailing flange and a discontinuous masonry structure exterior, where between bricks or blocks there exist mortar or grout valleys, and where typically a masonry sill projects past the exterior most plane of the structure.

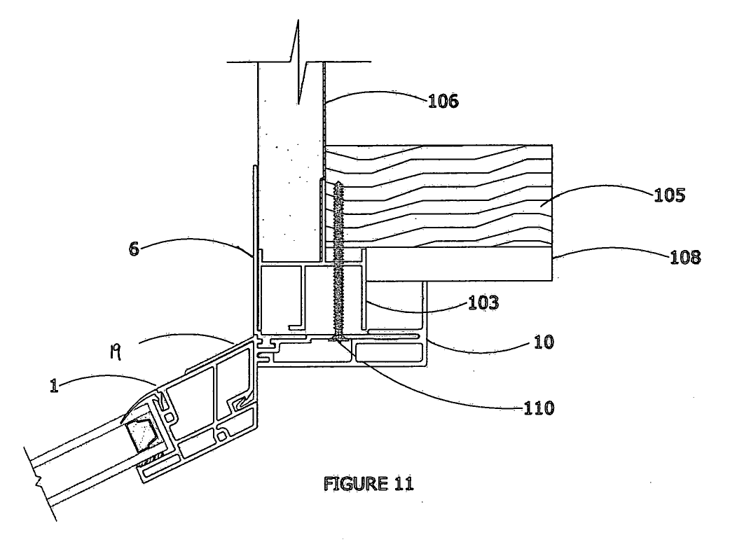

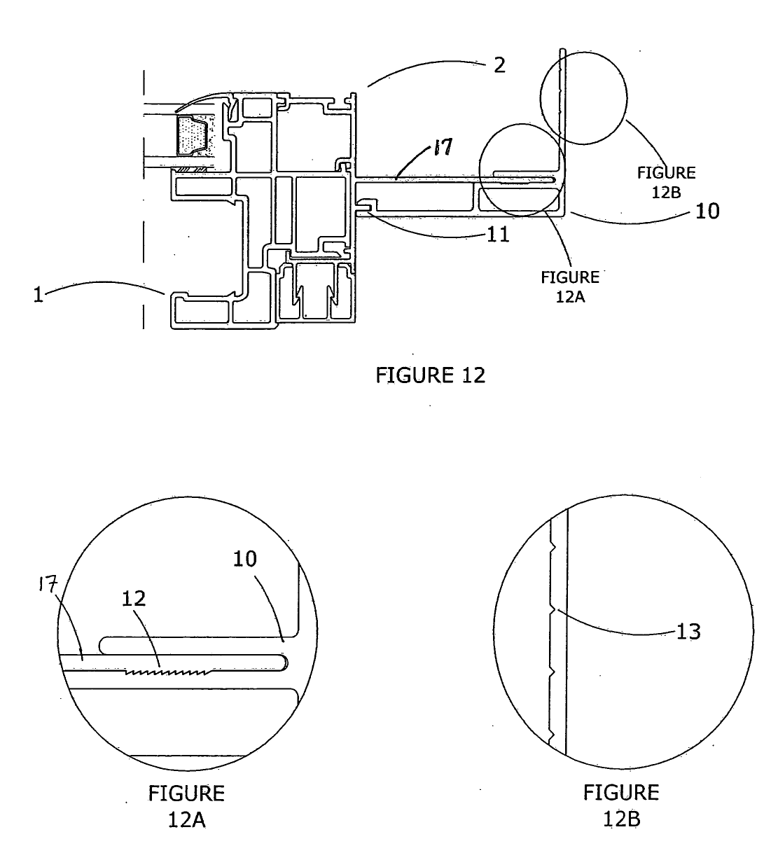

Referring to FIG. 11, a preferred embodiment of the invention can be seen in a replacement application where the garden window frame 1 with head sub member frame 3 is installed where trim piece 10 has finished the opening interior, covering existing window frame head 103 and fastener 110 and providing in a utilitarian manner a finish without additional fasteners. The trim piece 10 can be extruded from an easily field-fabricated material such as a plastic, making the interior opening finish a matter of simply cutting the trim pieces to length, snapping off the vertical trim flange at the appropriate location, and sliding them into place. Referring to FIGS. 12 and 12A, it can be seen that the trim piece locks in place on sub frame members 2, 3, and 4, by means of barbs 12 on flange 17, and is held in place at the garden window face by pocket 11. Barbs 12 may be provided on the upper or lower (as shown) surface of flange 17. Referring to FIG. 12B, it can be seen that the snap off grooves 13 provide a method for accommodating opening variances in a simple, field-applicable manner.

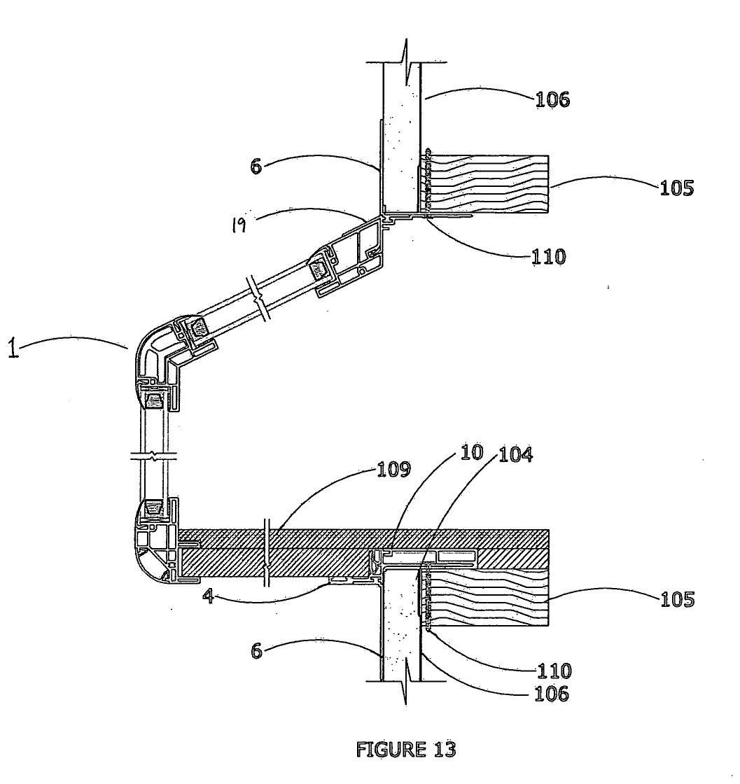

Referring to FIG. 13, a preferred embodiment of the invention can be seen in a new construction application using the garden window frame 1 with head sub member 3, sill sub member 4, and trim piece 10, where the plane presented by the flush surface created by sill sub member 4 is covered with a fitted piece such as granite tile 109, providing aesthetic continuity with the interior. This is a fairly typical garden window application in a kitchen installation, and with a radial nailing flange is accomplished by precisely aligning the sill interior of the garden window with the structure framing. With the opening parallel flange and trim of sill sub frame member 4, precise alignment is accomplished merely by setting sill sub frame member 4 on structure frame sill member 105 and securely fastening.

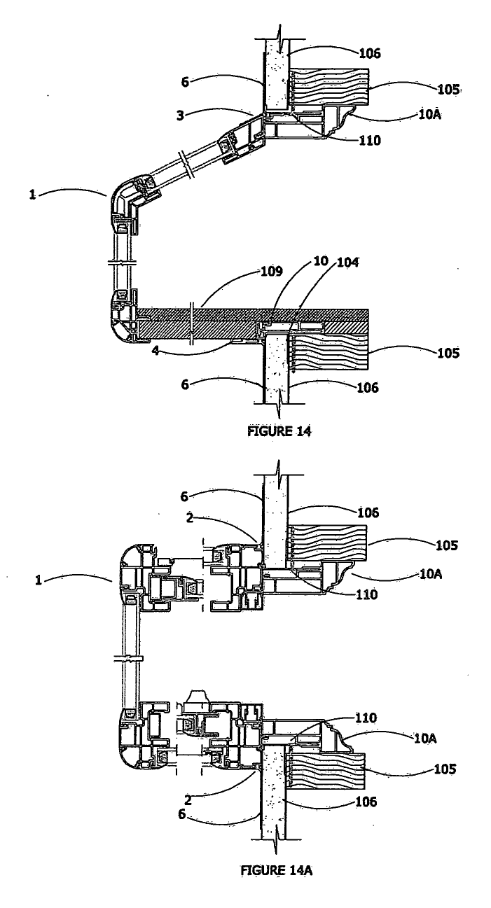

Referring to FIG. 14 another embodiment of the invention can be seen where an ornamental trim piece 10A is configured to the interior as decorative coving in one possible permutation, showing the general applicability of ornamental trim pieces in finishing interior openings simply, with reduced labor expenditure.

The invention has been described using window sub frame members 2, 3 and 4 designed for a garden window, and is not intended as a limitation on the scope of the invention. Further, a garden window sub frame member incorporating two flanges has been described. The concepts described herein, however, apply to garden window frame members incorporating more that two flanges. If a garden window frame member includes or incorporates more than two flanges, different functional frame members having different flange combinations could be created from the garden window frame members using the concepts disclosed in this detailed description.

Further, although the invention has been described in terms of exemplary embodiments, it is not limited thereto. Rather, the appended claims should be construed broadly, to include other variants and embodiments of the invention which may be made by those skilled in the art without departing from the scope and range of equivalents of the invention.

What is claimed is:

1. A sub flame member for inclusion in a garden window frame assembly mounted in an opening in a wall of a structure, the structure having an interior wall and an exterior wall, the opening defined by surfaces perpendicular to the interior and exterior walls, said sub frame member comprising an elongated piece having an outer surface disposed proximate to one of said opening surfaces, an inner surface disposed opposite to said outer surface, a window-facing side disposed to engage a garden window, a wall-facing side disposed opposite to said window-facing side, and at least one channel formed in said piece along said outer surface, and a flange for watertight engagement in said channel such that said flange extends substantially in a plane that is about parallel to said wall-facing side.

2. The sub frame member of claim 1 wherein said flange further comprises an interior portion adjacent to said channel that extends substantially in a second plane that is about perpendicular to said first plane.

3. The sub frame member of claim 1 wherein said channel comprises an elongated slot having at least one lip thereon, and said flange includes an extension for slidable engagement with said slot.

4. A garden window sub frame for receiving and supporting a garden window, said sub frame configured for mounting in an opening in a wall of a structure, the structure having an interior wall and an exterior wall, the opening defined by surfaces perpendicular to the interior and exterior walls, said sub frame comprising:
(a) two oppositely-disposed jamb members each having a top end and a bottom end;
(b) a header member overlapped by and attached to the top ends of said jamb members; and
(c) a sill member overlapping and attached to the bottom ends of said jamb members,
wherein each of said members comprises an elongated piece having an outer surface disposed proximate to one of said opening surfaces, an inner surface disposed opposite to said outer surface, a window-facing side disposed to engage said garden window, a wall-facing side disposed opposite to said window-facing side, at least one channel formed in said piece along said outer surface, and a flange for watertight engagement in said channel such that said flange extends substantially in a plane that is about parallel to said wall-facing side.

5. The sub frame of claim 4 wherein each flange further comprises an interior portion adjacent to said channel that extends substantially in a second plane that is about perpendicular to said first plane.

6. The sub frame of claim 4 wherein each channel comprises an elongated slot having at least one lip thereon, and each flange includes an extension for slidable engagement with said slot.

7. The sub frame of claim 4 wherein the ends of each of said flanges are angled such that they complement the edges of adjacent flanges allowing for watertight attachment of the ends of the flanges to each other.

8. The sub frame of claim 5 wherein the interior portion of the flange adjacent to said sill member is disposed parallel to and in a plane with a bottom interior surface of said garden window to provide a contiguous flush surface for post installation application of finish material.

9. A sub frame member for inclusion in a garden window frame assembly mounted in an opening in a wall of a structure, the structure having an interior wall and an exterior wall, the opening defined by surfaces perpendicular to the interior and exterior walls, said sub frame member comprising an elongated piece including a first extension having an outer surface disposed proximate to one of said opening surfaces and an inner surface disposed opposite to said outer surface, and a second extension having a window-facing side disposed to engage a garden window and a wall-facing side disposed opposite to said window-facing side, wherein a plurality of barbs are provided on one of the surfaces of said first extension for interlocking with a trim piece.

10. The sub frame member of claim 9 wherein a third extension is provided on said elongated piece, and said trim piece includes a pocket for engagement with said third extension.

11. The sub frame member of claim 9 wherein said trim piece includes a plurality of elongated grooves along which portions of said trim piece may be snapped off to adjust the size of said trim piece.

12. The sub frame member of claim 9 wherein said trim piece has an external ornamental appearance.

13. A method for installing a garden window and sub frame assembly into an opening in a wall of a structure, the structure having an interior wall and an exterior wall, the opening defined by surfaces perpendicular to the interior and exterior walls, said sub frame assembly comprising:
1. two oppositely-disposed jamb members each having a top end and a bottom end;
2. a header member overlapped by and attached to the top ends of said jamb members; and
3. a sill member overlapping and attached to the bottom ends of said jamb members,
wherein each of said members comprises an elongated piece having an outer surface disposed proximate to one of said opening surfaces, an inner surface disposed opposite to said outer surface, a window-facing side disposed to engage said garden window, a wall-facing side disposed opposite to said window-facing side, said installation comprising the steps of
a. attaching the elongated pieces of said sub frame assembly into said opening using fasteners inserted through each of said members and into the surfaces of said opening; and
b. attaching the garden window to said sub frame assembly.

14. The method of claim 13 comprising the additional step of attaching a window frame into said opening to form the surfaces of the opening, and attaching said fasteners through said members into said window frame.

15. The method of claim 13 wherein each piece further comprises at least one channel formed therein along said outer surface, and a flange for watertight engagement is provided in said channel such that said flange extends substantially in a plane that is about parallel to said wall-facing side, and comprising the additional step of attaching said flanges to said exterior wall.

16. The method of claim 13 comprising the additional step of attaching a trim piece to the interior wall side of at least one of said sub frame members.

17. The method of claim 13 comprising the additional steps of:
c. attaching a trim piece on the bottom interior surface of the garden window to provide a contiguous flush surface; and
d. installing finish material on said flush surface.

18. A sub frame member for inclusion in a garden window frame assembly mounted in an opening in a wall of a structure, the structure having an interior wall and an exterior wall, the opening defined by surfaces perpendicular to the interior and exterior walls, said sub frame member comprising an elongated piece having an outer surface disposed proximate to one of said opening surfaces, an inner surface disposed opposite to said outer surface, said piece further comprising an elongated extension having a window-facing side disposed to engage a garden window and a wall-facing side disposed opposite to said window-facing side.

19. The sub frame member of claim 16 wherein at least one channel is formed in said piece along said outer surface, and a flange is provided for watertight engagement in said channel such that said flange extends substantially in a plane that is about parallel to said wall-facing side.

20. The sub frame member of claim 17 wherein said flange further comprises an interior portion adjacent to said channel that extends substantially in a second plane that is about perpendicular to said first plane.

21. The sub frame member of claim 17 wherein said channel comprises an elongated slot having at least one lip thereon, and said flange includes an extension for slidable engagement with said slot.
